(19) United States
(12) Patent Application Publication
(10) Pub. No.: US 2003/0193894 A1
(43) Pub. Date: Oct. 16, 2003

(54) Method and apparatus for early zero-credit determination in an infiniband system

(76) Inventors: S. Paul Tucker, Ft Collins, CO (US); Edmundo Rojas, Fort Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/122,455

(22) Filed: Apr. 12, 2002

(51) Int. Cl. H04L 12/26

(52) U.S. Cl. 370/235; 709/229

(57) ABSTRACT

An early detection system is presented in which flow control logic is used to continually assess the capacity of a buffer memory. The flow control logic maintains an update of the buffer memory based on the buffer memories ability to store information associated with one of eight virtual lanes. As a result of the assessment, the flow control logic is capable of generating an early full detect signal. The early full detect signal denotes the capability of the buffer memory to hold packet information in a specific virtual lane. Packet checker logic receives the early full detect signal and assesses the first byte (e.g. first three bits) of a packet header, to determine whether the buffer memory can store information. If the packet passes the early detect test a second test is performed to determine if the buffer memory has enough space to store the packet. Should the buffer memory be unable to store information, the packet is discarded. If there is enough space in the buffer memory to store information, additional processing is performed to determine if the buffer memory has enough space to store the packet. As a result of the foregoing method and apparatus, several processing cycles are saved in processing the packet.

### BACKGROUND OF THE INVENTION

1. Field of the Invention

This invention relates to packet processing. Specifically, the present invention relates to data packet flow control.

2. Description of the Related Art

Data communications has dramatically increased in the past decade. The World Wide Web or the Internet as it is often called has increased in sophistication and complexity. As Internet technology has advanced, the amount of users on the Internet have increased and ultimately, the amount of traffic communicated across the Internet has increased. Simple twisted pair technologies have been replaced by more advanced optical technologies to provide greater throughput and capacity. Standards for enabling manufacturer interoperability have been developed to create a ubiquitous environment. For example standards such as the Peripheral Connection Interface (PCI) specification have developed for facilitating communication between disparate devices. Protocols such as the Transport Control Protocol (TCP)/Internet protocol(IP) have developed, to provide mechanisms for sharing information across this ubiquitous environment.

Technologies and standards have been developed to create more efficiencies and to increase the processing of data flowing across the Internet. For example, chip technology has continued to increase in speed. In addition, methods of processing data, such as message fragmentation and encapsulation are now deployed. These methods take end-user messages and divide them into packets of information for transmission across the Internet. With the advent of message fragmentation, protocols have developed for optimizing the flow and processing of these packets. Some of these new protocols and standards take advantage of increases in bandwidth resulting from new hardware technologies such as optical technologies. However, many of these standards are not optimized for the most efficient processing of information.

One area where tremendous efficiencies and improvements can be made, is in the area of packet processing. For example, a typical data packet compliant with a standard or specification, includes information on the packet size and the packet type. However this information is typically embedded well within the packet. Therefore a communications device, which has limited space for packet processing, has to partially or fully evaluate a packet before the device can determine whether it can process (e.g. store or forward) the packet. In cases where the communications device is unable to process the packet due to lack of memory or the time consumed by pipeline processing the header and then the remainder of the packet; precious processing time and cycles are lost, as the communications device evaluates the packet. When you consider the fact that packets take several hops from their originating point to their destination and that at each hop, a device may have to perform this evaluation; it is easy to recognize the inefficiencies resulting from this method of evaluation. In addition, any attempts to depart from these standardized methods of evaluating packets, must be compliant with the overall standard or protocol that is being used by the device or system.

As a result, there is a need for optimizing communications compliant with standards. Specifically, there is a need for a method of optimizing the evaluation of standards compliant packets. Lastly, there is a need for increasing the speed and efficiency of packet processing, while still adhering to standards.

### SUMMARY OF THE INVENTION

A method and apparatus for quickly determining the ability of a receiving device to process a packet is presented. An early detection method is presented, in which information in a packet header is analyzed to determine if a receiving device can process a packet. A buffer memory for storing a packet is continually assessed to determine whether the buffer memory is capable of storing the packet. An early detection signal is generated from the assessment and used to perform an early detection test on an incoming packet header. If the buffer is unable to store the packet, the packet is discarded without processing the packet header. However, if a packet passes the early detection test, a second test is performed to determine if the buffer can store the full packet.

A memory stores first data associated with a virtual lane. Flow control logic coupled to the memory, generates early detect information in response to the first data associated with the virtual lane. A packet checker is coupled to the flow control logic. The packet checker receives packet information associated with the virtual lane and receives the early detect information. The packet checker processes the packet information associated with the virtual lane in response to the early detect information.

### BRIEF DESCRIPTION OF THE DRAWINGS

FIG. 1 is a diagram of an Infiniband stack overlaid on an Open System Interconnection (OSI) protocol stack.

FIG. 2 is a high-level block diagram of the present invention.

FIG. 3 is a block diagram of an embodiment of the present invention.

FIG. 4 is a block diagram of a packet checker presented in FIG. 3.

FIG. 5 is a flow diagram of a method implemented by the packet checker presented in FIG. 4.

FIG. 6 is a block diagram of a virtual lane buffer presented in FIG. 3.

FIG. 7A is a “packet start” state machine for the packet stuffer located in the virtual lane buffer presented in FIG. 6.

FIG. 7B is a “packet stuffer” state machine for the packet stuffer located in the virtual lane buffer presented in FIG. 6.

FIG. 8 is a block diagram of flow control logic presented in FIG. 3.

FIG. 9 is a block diagram of free buffer space logic presented in FIG. 8.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The method and apparatus of the present invention is discussed within the context of an Infiniband (e.g. Infiniband Release 1.0, 2000, by Infiniband Trade Association) Architecture. Specifically, one embodiment of the present invention is implemented in a switch. However, it should be appreciated that the present invention may be implemented with respect to other standards compliant technologies and may be implemented in a variety of communications technologies such as switches, routers, channel adapters, repeaters and links that interconnect switches, routers, repeaters and channel adapters.

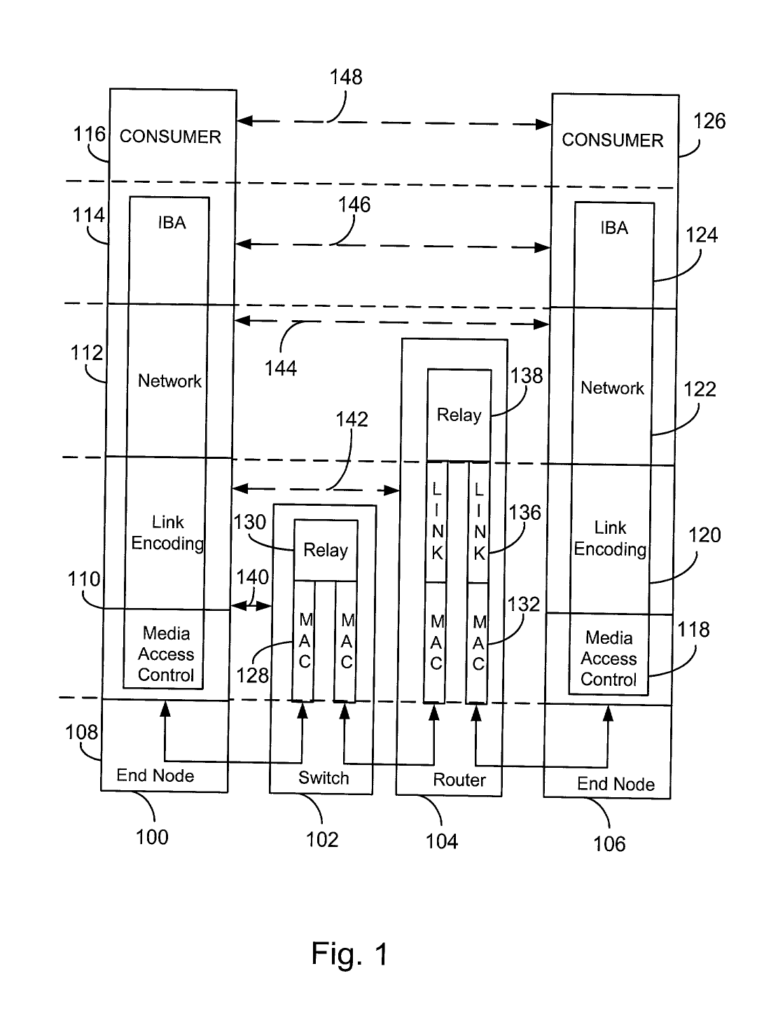

FIG. 1 presents an Infiniband protocol stack within the context of the Open System Interconnection (OSI) model, which has been promulgated by the International Standards Organization (ISO). End-Nodes 100 and 106 are displayed. The end-nodes, 100 and 106 communicate across a switch 102 and a router 104. The OSI model defines a physical layer 108, a link layer 110, a network layer 112, a transport layer 114, and upper level protocol layers 116. The Infiniband specification defines a media access control layer 118, a link-encoding layer 120, a network layer 122 and an Infiniband Architecture (IBA) Operations Layer 124.

Communications devices compliant with the Infiniband Architecture such as switch 102 and router 104 implement the media access control layer 118, as shown by 128 and 132. Routers and switches compliant with the Infiniband Architecture implement link-encoding 120, in a link layer and a packet relay layer, 136 and 130 respectively. Lastly, routers compliant with the Infiniband Architecture implement network layer functionality 122, in a packet relay implementation, as shown by 138.

Infiniband compliant operations usually include transactions 148, between consumers or end-users in End-Nodes 100 and 106. The transactions are fragmented into messages 146, which are communicated using the transport layer 114. The messages are then fragmented into data packets 144 for routing outside of a local network (e.g. inter-subnet routing), and data packets 142 for routing within a local network (e.g. subnet routing). The data packets 142 and 144 are the end-to-end, routable unit of transfer within the Infiniband Architecture. Flow control 140 is performed between media access units (MAC) 118 in the End-nodes 100, 106 and the media access units (MAC) 128 and 132, in the switch 102 and the router 104, respectively.

The present invention is primarily implemented in the link layer 110 of the OSI model and in the Link-encoding layer 120 of the Infiniband Architecture. In one embodiment, the method and apparatus of the present invention is implemented in an Infiniband complaint switch such as 102, with most of the method of the present invention, being performed by the MAC layer 128 and the packet relay layer 130. However, it should be appreciated that since the Infiniband Architecture is an integrated architecture, other layers such as the physical layer 108 would also be involved in the implementation of the method and apparatus of the present invention.

An Infiniband compliant data packet includes, in data order, a local route header for performing subnet routing 142, a global route header for performing inter-subnet routing 144, a base transport header, an extended transport header, an immediate data header, a message payload, an invariant cyclical redundancy check and a variant cyclical redundancy check. Each of these data groupings has a predefined length, for example, the local route header is eight bytes long or two word lengths (e.g. a word length equals four bytes). As noted from the ordering of the information, the local route header is the first portion of the packet that enters a processing device. By processing the first byte in the local route header (e.g. early detect test), the method and apparatus of the present invention is able to quickly determine the ability of a communicating device to store and process the packet. Should a device fail the early detect test; the packet is discarded prior to further analysis of the packet. If the packet passes the early detection process and is not discarded, then the packet length field is analyzed to determine the ability of the device to store the packet. This second step may be referred to as the packet length test.

In the Infiniband Architecture packets are communicated in virtual lanes. A virtual lane is a communication path (e.g. communications link) shared by packets from several different end-nodes, end-users or transactions. In the present embodiment of the invention, eight virtual lanes are defined, however, the Infiniband Architecture provides for 15 virtual lanes. Therefore, it should be appreciated that the method and apparatus of the present invention may be applied irrespective of the number of virtual lanes. Separate buffering and flow control is provided for each virtual lane and an arbiter is used to control virtual lane usage and manage the flow of packets across virtual lanes.

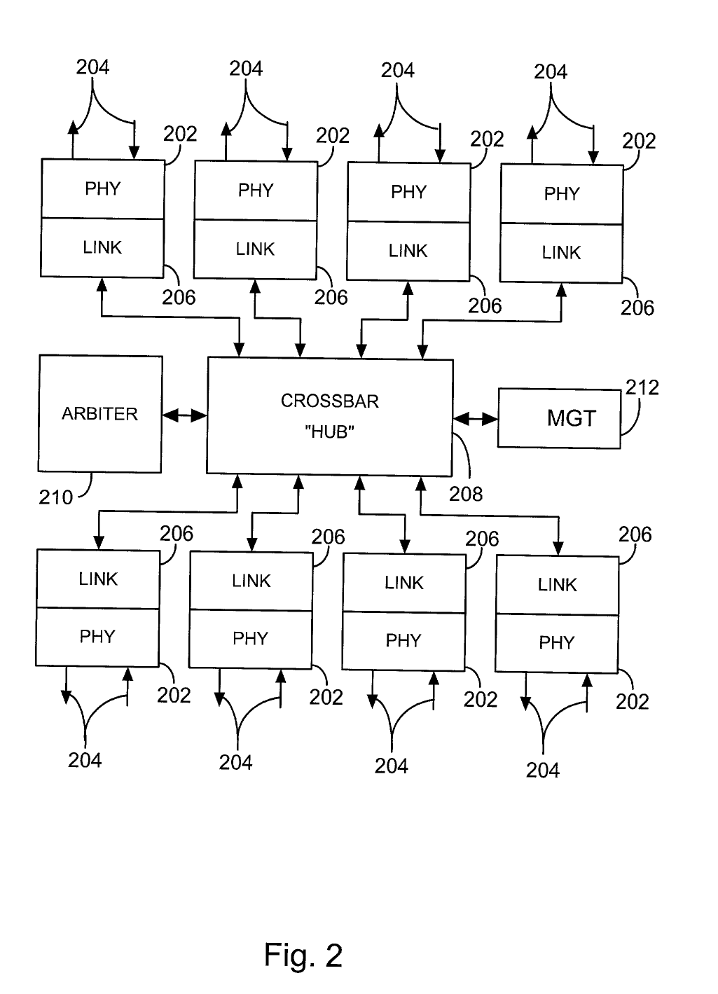

FIG. 2 displays a high-level block diagram of the present invention. In one embodiment, the method and apparatus of the present invention is implemented in an Infiniband compliant switch as shown in FIG. 2. In FIG. 2 a physical layer block 202 is shown. The physical layer block 202 provides physical layer processing and management such as media control and signaling. For example, in the present embodiment, each physical layer block 202, has 1× and 4× (e.g. Infiniband specification provides for 1×, 4×, 12×) capacity as shown by 204. As a result, four pairs of twisted pair wires (e.g. 4×) are used for incoming traffic and four pairs of twisted pair wires (e.g. 4×) are used for outgoing traffic. In the 4× implementation, data is striped across all four incoming and outgoing twisted pairs, increasing the bandwidth by a factor of four over a 1× implementations (e.g. where incoming and outgoing data would communicate across one pair of twisted pair wires).

The physical layer block 202 interfaces with a link layer block 206. The link layer block 206 includes the logic and functionality of the present invention. The link layer block 206 connects to a crossbar switch 208, which switches incoming and outgoing traffic. Arbiter 210 controls the crossbar switch 208. In addition, Arbiter 210 arbitrates (e.g. grants and denies request) traffic across the crossbar 208. The Arbiter 210 is managed by a management block 212, which performs management functions and system test.

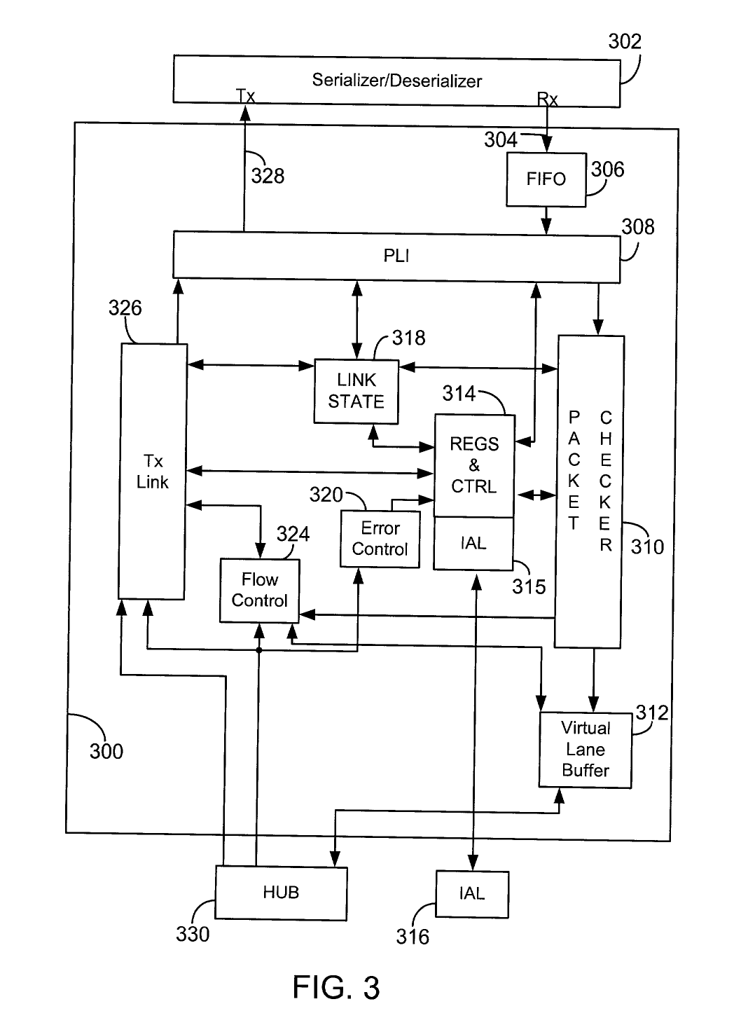

FIG. 3 displays a link layer (item 206 of FIG. 2) implementation of the present invention. The link layer implementation is displayed in a chip 300. In FIG. 3, serialize/de-serialize logic is shown as 302. The serialize/de-serialize logic 302 performs physical layer functions by taking serial bits and converting them into parallel bits. In the present embodiment, the serialize/de-serialize logic 302 takes serial bits and turns them into nine parallel bits (e.g. one data/control and eight data bits) as shown at 304. Each port in the present embodiment can operate in 1× or 4× mode. In a 4× implementation, there are four sets of serialize/de-serialize logic units per port, as a result, 4×9-bits (e.g. 36 bits) are generated. The thirty six parallel bits 304 are input into a First-In, First-out (FIFO) buffer 306. The FIFO buffer 306 performs a rate matching function. Data coming from off the chip 300, is traveling at a separate rate and under a different clock speed than data being processed on the chip 300. The FIFO buffer 306 determines the clock speeds and makes adjustments for any difference in speed. The FIFO buffer 306 also performs channel-to-channel de-skew. Since in a 4× configuration each of the four channels from the four serialize/deserialize logic units can be delayed with respect to each another, the FIFO buffer 306 realigns the channels into a coherent word.

In the present embodiment, the FIFO buffer 306 feeds thirty six bits of data into a PHY/Link Interface (PLI) 308. The PLI 308, turns the nine bits of data into 32 bits of parallel data in 1× mode and 36 bits of data to 32 bits of parallel data in 4× mode. The PLI 308 inputs data into a packet checker 310 which functions as a receive link portion of the chip 300. The packet checker 310 receives and checks packets for further processing and then forwards the packets to a virtual lane buffer 312. The virtual lane buffer 312 stores data packets associated with a specific virtual lane.

Control registers are shown as 314. The control registers monitor the transfer of packets on the link and perform state detection of the link. The control registers are connected to a first internal access loop interface 315. The first internal access loop interface 315, is in communication with a second internal access loop interface 316. The two internal access loop interfaces 315, 316, facilitate external access to registers and other logic within the chip 300. A link state machine 318 is shown. The link state machine 318, keeps track of the state of the link. For example the link state machine will keep track of whether the link is in an up, down, training, or utilized state. Error control logic 320 is shown. The error control logic 320 keeps track of errors communicated through a Hub port 330, from other areas of the chip 300.

Flow control logic 324 is shown. The flow control logic 324 implements a state machine that manages the flow of traffic on a link. Specifically, flow control logic 324, manages the flow of packets between the packet checker 310 and the virtual lane buffer 312. Flow control logic 324, is connected to the packet checker 310, the virtual lane buffer 312, the Hub port 330 and transmit link logic 326. The Hub port 330 is a port to the crossbar (item 208 FIG. 2), used to facilitate signal transfer between the crossbar and the transmit link logic 326, the virtual lane buffer 312 and flow control logic 324. The transmit link logic 326, transfers 36 bits of data to the PLI 308. The PLI 308, then turns the 36 bits of data into a four 9-bit streams in a 4× configuration. The transmit link logic 326, also communicates flow control packets generated by the flow control logic 324, out to the serialize/de-serialize logic 302 using the PLI 308.

The packet checker 310, the virtual lane buffer 312 and the flow control logic 324, work in conjunction to implement the method of the present invention. The virtual lane buffer 312 stores packets in a contiguous memory space. Each packet is associated with a virtual lane. The flow control logic 324 keeps a status of the amount of memory available in each virtual lane. The flow control logic communicates this status information to the packet checker in the form of an 8-bit signal (e.g. in the present embodiment). The 8-bit signal includes one bit associated with each virtual lane. The 8-bit signal is known as the early detect signal. The packet checker receives the first byte of a packet header from the PLI 308 and the early detect signal from the flow control logic 324. Based on the early detect signal, generated using the first byte of the packet header, the packet checker can determine whether the virtual lane buffer 312 is full or not full. A more detailed discussion of the packet checker 310, the virtual lane buffer 312 and the flow control logic 324 is given below.

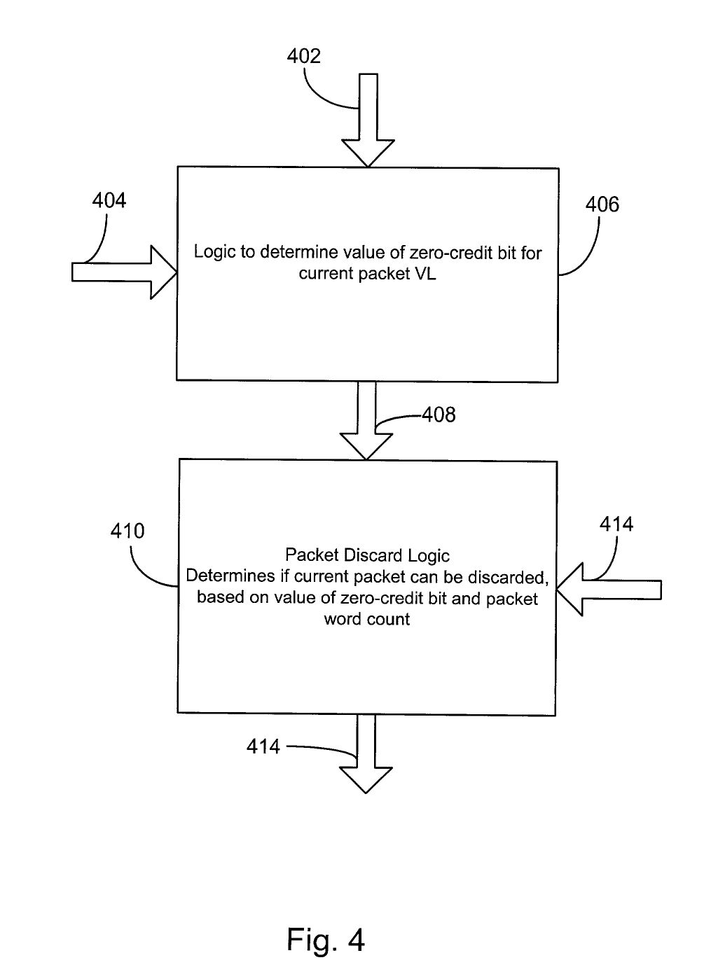

FIG. 4 displays a block diagram of the packet checker (e.g. item 310 of FIG. 3). In FIG. 4 input packet information is shown 402. The input packet information includes the first byte of an incoming packet. In the method of the present invention, an incoming packet as shown by 402 (e.g. input packet information), is searched for the first byte in the header. The first byte in the header of a packet compliant with the Infinite specification, will include the virtual lane designated for use by the packet. Early detect information 404, is input into zero credit logic 406, from the flow control logic (e.g. item 324 of FIG. 3). The early detect information 404 gives an indication of whether a specific virtual lane is full or not full. Within the early detect information 404, a zero bit value is used to denote not full and a one bit value is used to denote full. A zero bit value in the current embodiment suggests that the virtual lane buffer has room to store information. A one-bit value suggests that the virtual lane buffer does not have room to store information.

The early detection information 404 is maintained by the flow control logic 324 of FIG. 3. The status of each virtual lane is continually updated so that the early detection information 404, includes the status of each virtual lane (e.g. space in virtual lane buffer associated with a virtual lane). Both the input packet information 402 and the early detect information 404 are fed into zero credit logic 406 which makes an early determination of the ability of a virtual lane to store information. The zero credit logic 406 is implemented using standardized digital technology, such as standard logic gates. A pass/fail signal 408 is sent to discard logic 410. The pass/fail signal is an indication of whether the packet passed the early detect test, based on the testing performed by the zero-credit logic 406. The zero-credit logic 406 performs the early detection test by using the virtual lane designation in the first byte of the incoming packet, to index into the early detect signal and determine the status of the virtual lane (e.g. full or not full).

The packet discard logic 410 is implemented using standardized digital technology. A word count is maintained by the system. A word is defined as four bytes therefore a 1× system would acquire a quarter of a word in one cycle time. Alternatively, a 4× system would acquire a full word (e.g. four bytes) in one cycle time. In the method of the present invention, the system waits to acquire a word, therefore each byte is stored until the full word is acquired. This allows the system to be scaled to accommodate 1× implementations, 4× implementations, 12× implementations and beyond. The early detect pass/fail signal 408 is input into the packet discard logic 410. In addition, a packet word count 414 is also input into the packet discard logic 410. Based on the early detect pass/fail signal 408 and the packet word count 414, the Packet discard logic 410, determines whether the virtual lane buffer can store information. Should the packet need to be discarded, a packet discard signal 414 is generated.

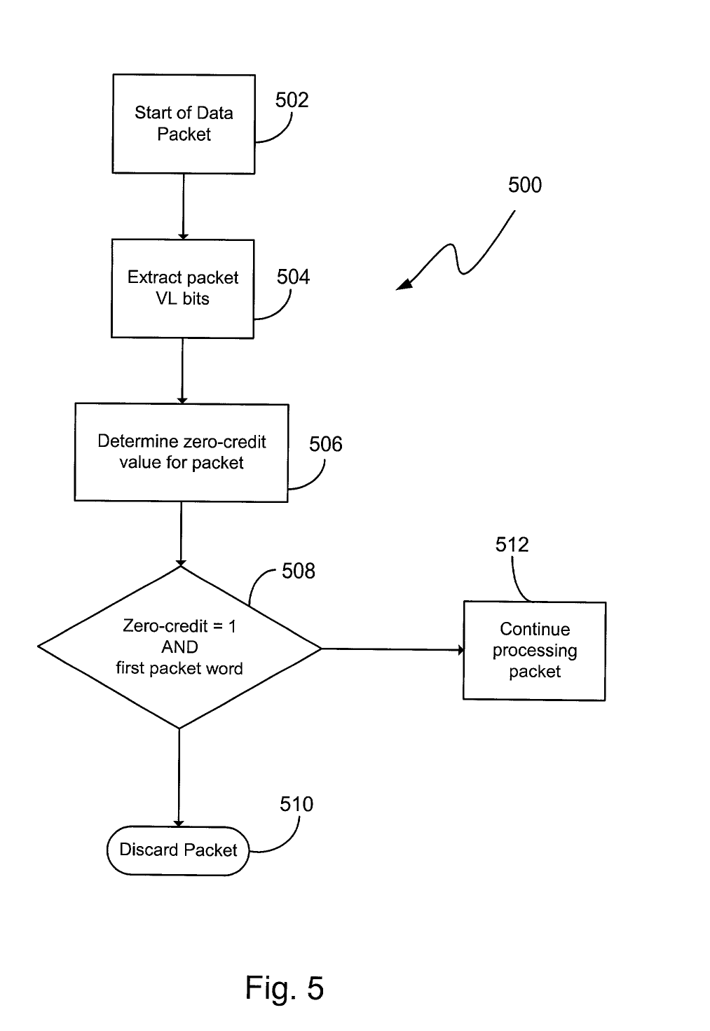

In FIG. 5, a flow diagram 500, of the packet checker methodology is presented. In the methodology of the present invention, a two-stage process is performed. First, an early detect check is performed, to determine if the buffer can store information. The early detect check is based on a continual assessment of the state of the virtual lane buffer. A full packet check is then performed, to determine whether the virtual lane buffer can store the packet. The full packet check is performed by processing the eleven bit packet length field located in the third header word.

In FIG. 5 an initial packet arrives at the packet checker (e.g. item 310 of FIG. 3), as shown at 502. Three bits of the first byte in the packet header, are extracted as shown at 504. The extracted bits designate the virtual lane that the packet will use. The three bits are used to index into the early detect signal coming from the flow control logic as shown by 506. For example, if the three bits identify virtual lane six, a check will be made of the status of virtual lane six, by looking at the early detect bit associated with virtual lane six. If the early detect bit associated with virtual lane six indicates full, the packet is discarded. If the early detect bit associated with virtual lane six indicates not full (e.g. the virtual lane buffer has space), then an early detect pass signal is generated and the packet is assessed. In the present embodiment, assessment of the packet would include processing the eleven bit packet length field, located in the third header word. However, other methods of processing the packet length are also contemplated by the present invention and are within the scope of the present invention.

The packet discard logic then receives an early detect pass signal and then waits for a full word, as shown by 508. A logical comparison is made to see if the early detect signal is one and the first word is available. If the early detect signal is one and the first word is available the packet is discarded as shown by 510. If the early detect signal is zero and the first word is available we continue to process the packet as shown at 512.

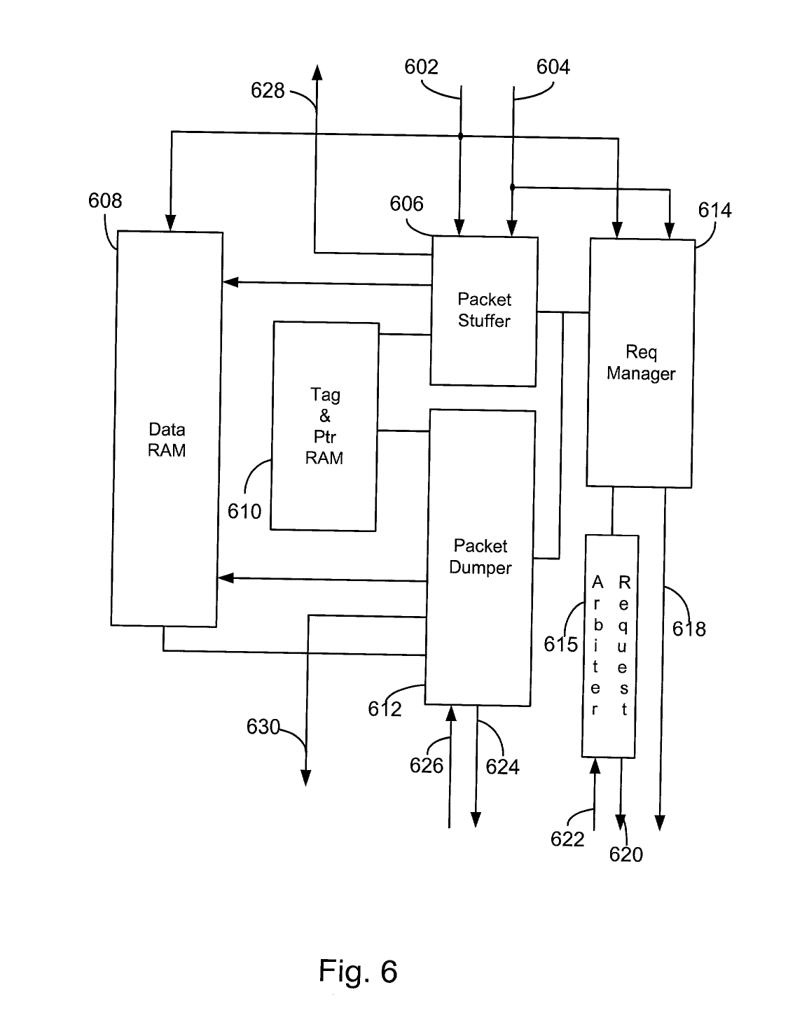

FIG. 6 depicts an internal block diagram of the virtual lane buffer (e.g. item 312 of FIG. 3). In FIG. 6, packet data comes from the packet checker (e.g. item 310 of FIG. 3) as shown by 602. Packet control information is also received from the packet checker as shown by 604. Both the packet data 602 and packet control information 604 are input into a packet stuffer 606. The packet stuffer 606 is responsible for writing packet data into a data RAM 608. A tag and pointer RAM 610 maintains a linked list of pointers which correlates to the location of packets in data RAM 608. The packet stuffer 606 works in conjunction with the tag and pointer RAM 610, to write packets contiguously into data RAM 608.

A packet dumper 612 also works in conjunction with tag and pointer RAM 610. The packet dumper 612 manages data reads from data RAM 608. A request manager 614 is connected to both packet stuffer 606 and packet dumper 612. The request manager 614 receives information from the arbiter (e.g. item 210 of FIG. 2), on packets coming in and out of the switch. The request manager 614, processes and manages request from the arbiter. Arbiter request, typically come through arbiter request logic 615, from a Hub as shown by 622. In addition, request are also communicated from the request manager 614, through the arbiter request logic 615 to the Hub as shown at 620. The request manager 614, can also communicate request and control information directly to the Hub, as shown by 618.

The request manager 614 keeps track of the request generated to the arbiter and messages coming back from the arbiter (e.g. which packet the arbiter made a communications grant for). The packet dumper 612 also interfaces directly with the Hub by reading data out of the data RAM 608, through the packet dumper 612 and through connection 624 to the Hub. Control information is also communicated from the Hub directly to the packet dumper 612, as shown at 626.

Once a word is written into the RAM 608, the packet stuffer 606 communicates this information to the flow control logic through 628. The packet stuffer 606, will typically generate a decrement signal on connection 628 for every word written into RAM 608. The packet stuffer 606 will also use connection 628 to provide the flow control logic with information on which virtual lane has been decremented. The packet dumper 612 has communication with the flow control logic, as shown by 630. The packet dumper 612 generates a signal when it reads packets out of the memory (e.g. an increment signal). In addition, the packet dumper 612 communicates information on which virtual lane has released data, to the flow control logic. Lastly, the packet dumper 612 communicates how much memory has been released, to the flow control logic.

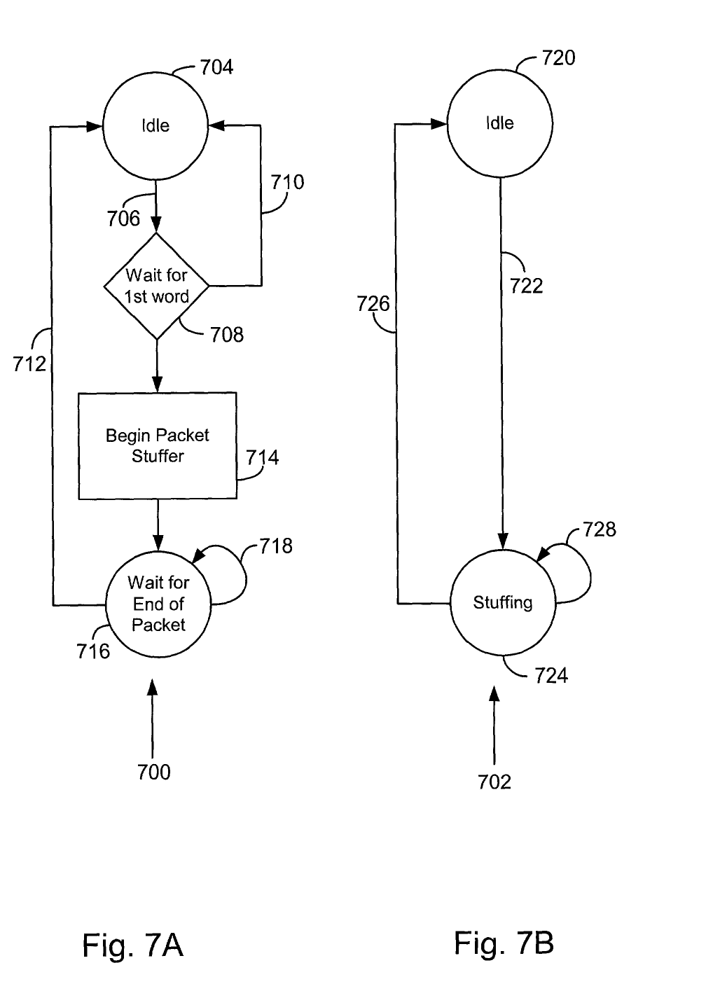

A state machine depicting the operation of the packet stuffer is shown in FIG. 7A. A “packet start” state machine is shown as 700. In the packet start state machine 700, the packet stuffer is initially in an idle state as shown by 704. Once a bit from an incoming packet is received, a packet start signal is sent from the packet checker as shown by 706. The packet stuffer waits for the first word. An early detect failure while waiting for the first word will abort the wait as shown by 710.

Once the packet has passed the early detect test, packet header processing continues. If the packet does not pass the early detect test; the state machine loops back into idle after discarding the packet as shown at 710. If the “packet start” state machine 700 receives the first word without an early detect failure, then a “packet stuffer” state machine 702 of FIG. 7B is triggered as shown by 714. The packet start state machine 700 waits until the end of packet as shown by 716. The packet start state machine 700 continues to loop back and wait until an end of packet data bits arrives as shown by 718. Once the end of packet designation has been located within the packet, the state machine loops back to the idle state to wait for the next start of packet, as shown by 712.

The “packet start” state machine 700 initiates the “packet stuffer” state machine 702, once a first word becomes available as shown at 714. Once the first word becomes available the packet stuffer is ready to write information into the RAM and the “packet stuffer” state machine 702 of FIG. 7B moves from a packet stuffer idle state as shown by 720, into a packet stuffing state as shown by 724. The packet stuffing state machine remains in packet stuffing state until the end of packet is received or some kind of packet abort such as a packet length failure occurs as shown by 728. Once the packet has reached an end of packet designation, the packet stuffer moves from the packet stuffing state back to the idle state as shown by 726. It is important to note that the packet stuffer does not move from the packet start state as shown by 700, to the packet stuffer state as shown by 702, until the first word is available. The first word does not become available until the system has passed the early detect test.

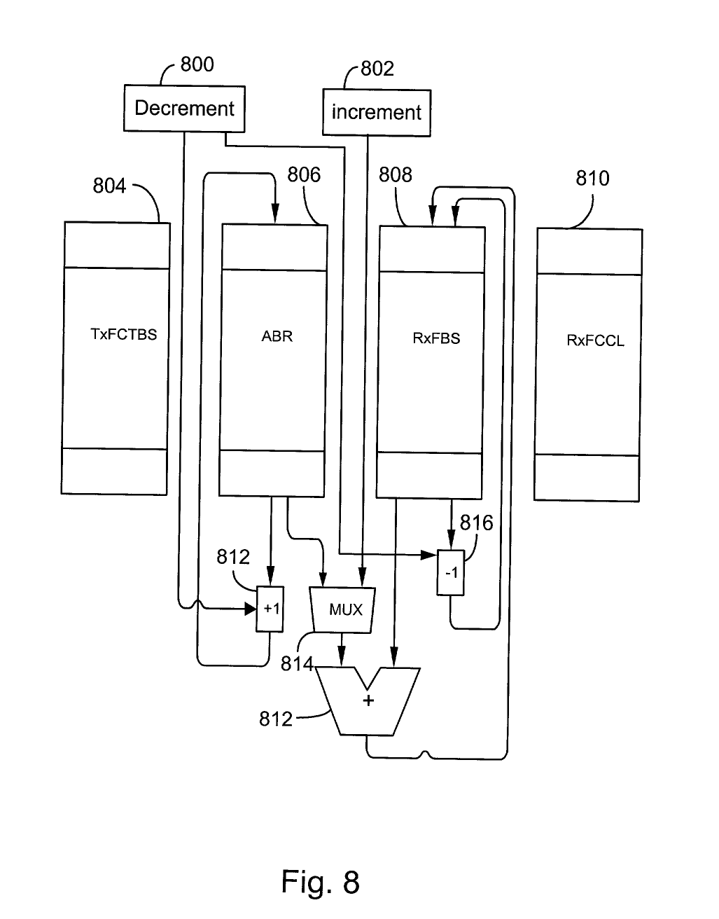

FIG. 8 displays a more detailed diagram of the flow control logic (e.g. item 324 of FIG. 3). In FIG. 8 signals are input into the flow control logic from the virtual lane buffer. Signals, such as packet stuffer decrement signals (e.g. signal 628 FIG. 6) are shown by block 800. In addition increment signals (e.g. signal 630 FIG. 6), are communicated from the packet dumper to the flow control logic, as shown by 802. The flow control logic in the present embodiment, consist of four register arrays. The flow control total block sent register array (T×FCTBS) 804 manages outgoing flow control packets. The Adjusted Blocks Received (ABR) register array 806, keeps track of the number of words received by a port after the port is initialized. The receive free block space register array (R×FBS) 808, tracks how much space is available in each virtual lane. Both the increment signals 802 and the decrement signal 800, are input into the receive free buffer space register array 808 and communicate status information from the virtual lane buffer to the flow control logic. A receive flow control register array (R×FCCL) 810 is also shown. The receive flow control register array keeps track of received flow control information. The register arrays interoperate with the decrement signals 800 and the increment signals 802 using adders 812, multiplexer 814 and decrementer 816.

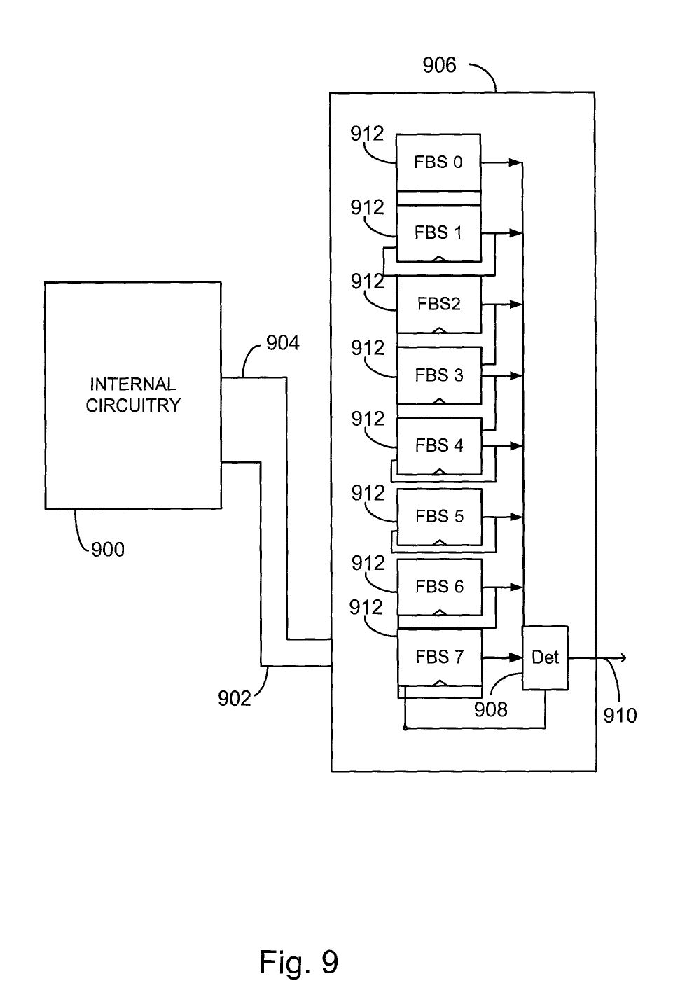

An internal block diagram of the receive free buffer space register array (e.g. item 808 of FIG. 8), is shown in FIG. 9. The internal block diagram of the receive free buffer space register array includes internal logic 900 and a free buffer space register array block 906, in which one virtual lane corresponds to each register. Signals coming from the packet dumper (e.g. item 612 of FIG. 6) are shown as 902 (e.g. increment signal). The signals increment the free buffer space register array, corresponding to a virtual lane, when the packet dumper reads information out of memory that is associated with the virtual lane. Signals coming from the packet stuffer (e.g. item 606 of FIG. 6) are shown as 904 (e.g. decrement signal). The signal from the packet stuffer decrements the register, corresponding to a virtual lane associated with the memory, that has stored additional information. Once a register shown as 912, corresponding to a virtual lane, is full and can no longer store information, a signal is then generated to the early detect logic shown as 908. An early detect signal 910 (e.g. previously shown as 404, FIG. 4) is generated to disclose that a specific virtual lane is unable to store information.

During operation of the virtual lane buffer, when a link is initialized (e.g. has just established a link or connection with another port), all buffers are set to empty. The free buffer space is then determined by the amount of memory in the free buffer space, divided by 1, 2, 4 or 8 virtual lane's depending on the number of virtual lanes implemented in the system. As packets corresponding to a virtual lane, are written into the memory, the decrement signal 904 is generated, signifying a decrease in the amount of memory available in the free buffer space. As packets are read out of the memory corresponding to a virtual lane, an increment signal 902 is generated corresponding to an increase in memory.

The increment signal 902 and the decrement signal 904, facilitate communication between the virtual lane buffer and the flow control logic. As a result, the flow control logic is able to maintain the status of the amount of memory available in free buffer space. As the amount of memory is increased or decreased the flow control logic is updated with the status of each virtual lane. Once a buffer reaches capacity (e.g. the memory does not have room to store information), the early detect logic 908 is triggered and an early full detect signal 910 is generated.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system comprising:
a memory storing first data associated with a virtual lane;
flow control logic coupled to the memory and generating early detect information in response to the first data associated with the virtual lane; and
a packet checker coupled to the flow control logic, the packet checker receiving packet information associated with the virtual lane and receiving the early detect information, the packet checker processing the packet information associated with the virtual lane in response to the early detect information.

2. A system as set forth in claim 1, wherein the packet checker is further coupled to the memory and processes the packet information associated with the virtual lane by generating output information which causes the memory to store second data associated with the virtual lane.

3. A system as set forth in claim 1, wherein the packet checker processes the packet information associated with the virtual lane by discarding the packet information associated with the virtual lane.

4. A switch comprising the system as set forth in claim 1, wherein the memory is coupled to the packet checker, the packet checker processing the packet information associated with the virtual lane by generating output information which causes the memory to store second data associated with the virtual lane.

5. A router comprising the system as set forth in claim 1, wherein the memory is coupled to the packet checker, the packet checker processing the packet information associated with the virtual lane by generating output information which causes the memory to store second data associated with the virtual lane.

6. An interface card comprising the system as set forth in claim 1, wherein the memory is coupled to the packet checker, the packet checker processing the packet information associated with the virtual lane by generating output information which causes the memory to store second data associated with the virtual lane.

7. A method of operating a system comprising the steps of:
storing first data associated with a virtual lane;
generating early detect information in response to the first data associated with the virtual lane;
receiving packet information associated with the virtual lane; and
processing the packet information associated with the virtual lane in response to the early detect information.

8. A system comprising:
a memory means for storing first data associated with a virtual lane;
flow control logic means coupled to the memory means, the flow control means for generating early detect information in response to the first data associated with the virtual lane; and
a packet checker means coupled to the flow control logic means, the packet checker means for receiving packet information associated with the virtual lane and receiving the early detect information, the packet checker means for processing the packet information associated with the virtual lane in response to the early detect information.
